(19) United States
(12) Patent Application Publication
(10) Pub. No.: US 2012/0027244 A1
(43) Pub. Date: Feb. 2, 2012

(54) SPEAKER

(76) Inventor: Wen-Tao Jiang, Shenzhen (CN)

(21) Appl. No.: 13/016,136

(22) Filed: Jan. 28, 2011

(30) Foreign Application Priority Data
Aug. 2, 2010 (CN) 201020278680.0

(51) Int. Cl. H04R 1/02

(52) U.S. Cl. 381/394

(57) ABSTRACT

A speaker includes a case including a center cavity and a body surrounding the center cavity, an electroacoustic transducer received in the center cavity of the case, and a pair of terminals assembled in the case. The body defines a main upper surface and a main lower surface opposite to the upper surface, and a plurality of sides coupled with the upper surface and the lower surface. Wherein, two opposite sides of the body respectively define a plat approximately upright to the sides, a projecting mass approximately uprightly extending from the sides and facing the plat, and a gap formed between the plat and the projecting mass. At least a portion of the terminals is sandwiched in the gaps, respectively.

### FIELD OF THE INVENTION

The present invention generally relates to the art of speakers, and more particularly, to a structure of a case of a speaker for assembling a pair of terminals therewith.

### RELATED ART OF THE INVENTION

Speakers are widely used in many types of portable electronic devices, such as mobile phones, notebook computers, hearing aids, for converting audio electrical signals to audible sounds. Gradually, sizes of the portable electronic devices have being designed more and more smaller for satisfying the consumer's needs. So, the speakers used in the portable electronic devices also should be developed to satisfy the trend of miniature.

Generally, a related speaker includes a case for receiving an electroacoustic transducer therein, and a pair of terminals for providing audio electrical signals to the electroacoustic transducer. The electroacoustic transducer includes a yoke, a magnet fixed to the yoke, a plate attached to an upper surface of the magnet, a coil suspended in a magnetic gap formed between the yoke and the magnet, and a diaphragm droved to move by the coil for producing sound waves. Each of the terminals defines a mounting section for being electrically connected to the coil in the case and a free section extending from the mounting section for being contacted with a PCB of the external electronic device. While assembling the pair of terminals into the case, the mounting section is uprightly inserted into a main surface of the case, and the free section projects from the main surface of the case. Then, a thickness of the speaker is the summation of a thickness of the case and a thickness of the free section, which increases the whole thickness of the speaker, and makes it is difficult to make a thinner speaker.

Therefore, an improved speaker that can resolve the problems mentioned-above is desired.

### BRIEF DESCRIPTION OF THE DRAWINGS

FIG. 1 depicts an isometric view of a speaker in accordance with one exemplary embodiment of the present invention;

FIG. 2 depicts an enlarged view of Area A in FIG. 1; and

FIG. 3 depicts an isometric exploded view of a case and a pair of terminals of the speaker in FIG. 1.

### DETAILED DESCRIPTION OF THE EXEMPLARY EMBODIMENT

Reference will now be made to describe one exemplary embodiment of the present invention in detail.

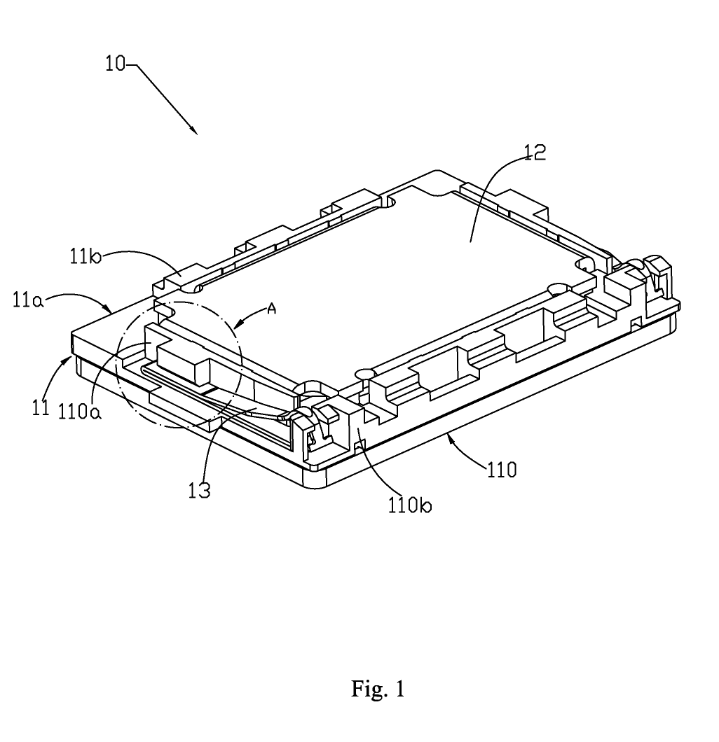

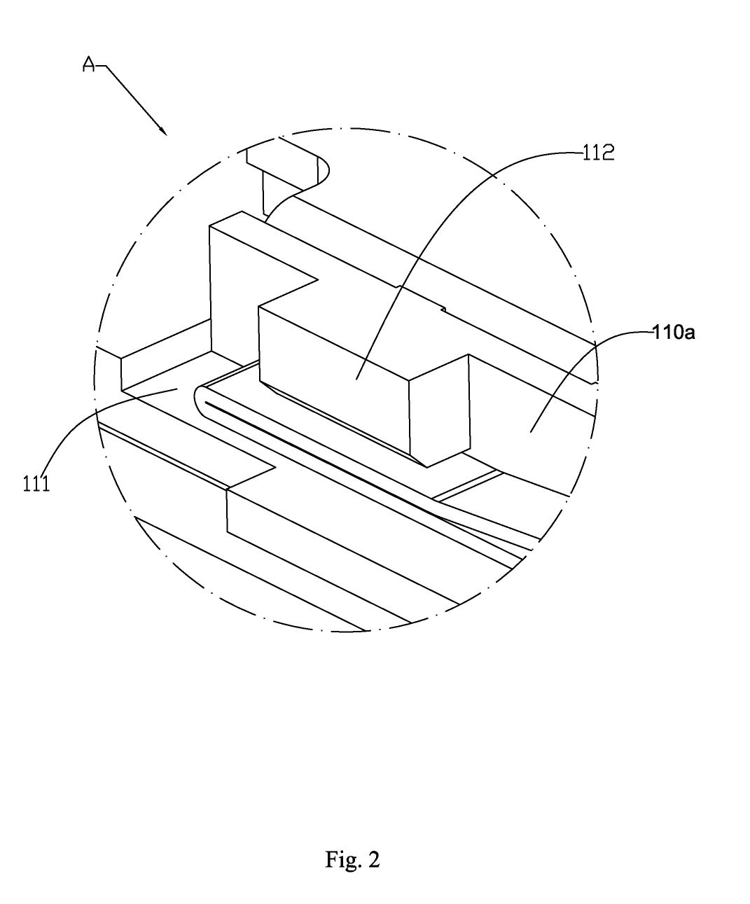

Referring to FIGS. 1-3, a speaker 10, in accordance with an exemplary embodiment of the present invention, includes a case 11, an electroacoustic 12 received in the case 11, and a pair of terminals 13 assembled in the case.

The electroacoustic transducer 12, for converting audio electrical signals to audible sounds, is a public-known transducer and generally includes a yoke, a magnet fixed to the yoke, a plate attached to the magnet, a coil suspended in a magnetic gap formed between the yoke and the magnet, and a diaphragm connected to the coil. In fact, the transducer 12 is not limited to the structures described above, and can make the present invention practical as long as it is capable of converting electrical signals into audible sounds.

The case 11 defines a center cavity for receiving the electroacoustic transducer 12 and a body 11a surrounding the center cavity. The body 11a of the case 11 defines a main upper surface 11b and a main lower surface (not shown) opposite to the upper surface 11b, and four sides 110 coupled with the upper surface 11b and the lower surface. The four sides 110 are divided into a pair of opposite short sides 110a and a pair of opposite long sides 110b.

Each short side 110a defines a plat 111 approximately upright thereto and a projecting mass 112 approximately uprightly extending therefrom. The projecting mass 112 faces the plat 111 and a gap 121 is formed between the plat 111 and the projecting mass 112. Furthermore, a length of the projecting mass 112 is shorter than a length of the plat 111.

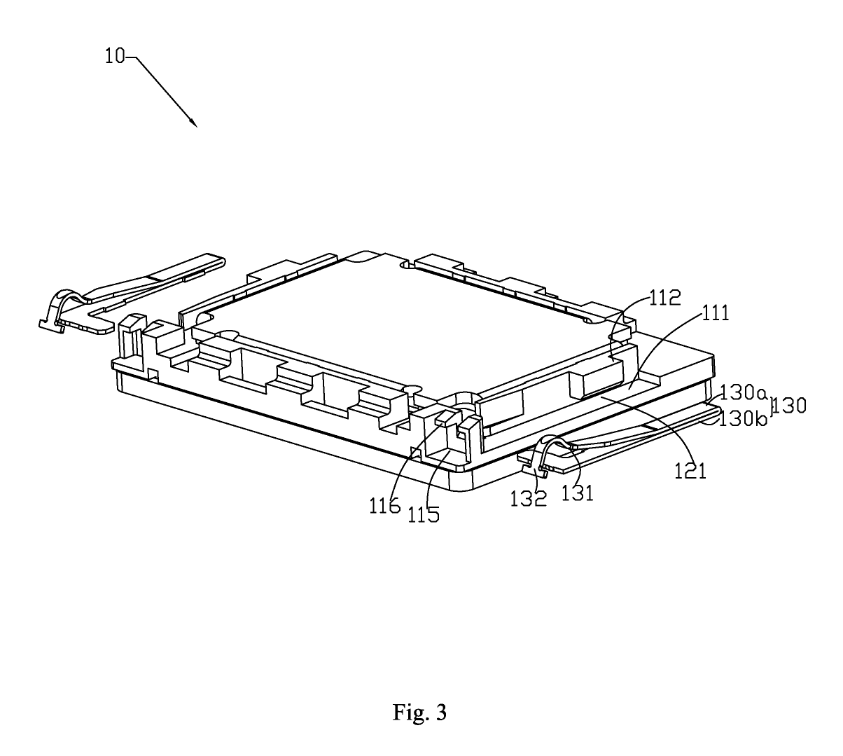

Referring to FIG. 3, each one of the pair of terminal 13 is made of a flexible metal plate, and the flexible metal plate is folded up so as to form an upper plate 130a and a lower plate 130b opposite to the upper plate 130a.

The upper plate 130a is bent, and the lower plate 130b is straight. A back section of the upper plate 130a is connected to a back section of the lower plate 130b, and a fore section of the upper plate 130a departs from a fore section of the lower plate 130b.

The fore section of the upper plate 130a is used for being electrically connected the PCB of the external electronic device. So, the fore section of the upper plate 130a is bended to form an arc 131, and defines a T-shaped end 132 bending toward the lower plate 130b.

While assembling the terminal 13 into the case 11, both of the back sections of the upper plate 130a and the lower plate 130b are sandwiched in the gap 121 between the plat 111 and the projecting mass 112 along a direction of upright to the side 110a, with the lower plate 130b attached to the plat 111. And, a height of the gap 121 is not greater than the summation of a thickness of the back sections of the upper plate 130a and a thickness of the back sections of the lower plate 130b, so, the terminal 13 can be firmly fixed in the case. Furthermore, the projecting mass is shorter than the plat, and located above the back section of the upper plate 130a, so that, the fore section of the upper plate is free for being electrically connected to the PCB of the external electronic device.

Furthermore, a length of the lower plate 130b is approximately equal to the flat 111, so as the lower plate 130b can be completely attached to the plat.

In order to control a place of the fore section of the upper plate 130a, a pair of poles 116 uprightly extending from the plat 111 are provided and spaced a distance each other so that the fore section of the upper plate 130a is sandwiched between the poles. And, in order to receive the T-shaped end 132, a house 115 formed between the poles 116 and a portion of side 110a of the case is provided.

Because, the terminal 130 is inserted in the side 110a of the case 11 along a direction of upright to the side 110a, a thickness of the speaker 10 can not extra increase. In other words, the thickness of the speaker 10 only approximately is the thickness of the case, not additionally extra thickness of another element.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A speaker, comprising:
a case comprising a center cavity and a body surrounding the center cavity, the body defining a main upper surface and a main lower surface opposite to the upper surface, and a plurality of sides coupled with the upper surface and the lower surface;
an electroacoustic transducer received in the center cavity of the case;
a pair of terminals assembled in the case;
wherein
each of the two opposite sides of the body respectively defines a plat approximately upright to the sides, a projecting mass approximately uprightly extending from the sides and facing the plat, and a gap formed between the plat and the projecting mass; and
at least a portion of the terminals is sandwiched in the gap.

2. The speaker as described in claim 1, wherein each terminal comprises a lower plate attached to the plat and an upper plate opposite to the lower plate, and both of back sections of the lower and upper plates are sandwiched in the gap.

3. The speaker as described in claim 1, wherein a length of the projecting mass is shorter than a length of the plat.

4. The speaker as described in claim 2, wherein the terminal is made of a flexible metal plate.

5. The speaker as described in claim 2, wherein a height of the gap is not greater than the summation of thicknesses of back sections of the upper and lower plates.

6. The speaker as described in claim 2, wherein, the fore section of the upper plate is configured an arc and has a T-shaped end bending toward the lower plate.

7. The speaker as described in claim 6, wherein two spaced poles are provide at the plat for sandwiching the fore section of the upper plate therebetween.

8. The speaker as described in claim 6, wherein a house adjacent to the poles is provide for receiving the T-shaped end of the upper plate.
